(19) United States
(12) Patent Application Publication
(10) Pub. No.: US 2021/0014486 A1
(43) Pub. Date: Jan. 14, 2021

(54) IMAGE TRANSMISSION

(71) Applicant: SZ DJI TECHNOLOGY CO., LTD., Shenzhen (CN)

(72) Inventor: Ning MA, Shenzhen (CN)

(21) Appl. No.: 17/033,871

(22) Filed: Sep. 27, 2020

Related U.S. Application Data
(63) Continuation of application No. PCT/CN2018/087089, filed on May 16, 2018.

(51) Int. Cl. H04N 19/107; H04N 19/18; H04N 19/91; H04N 19/172; H04N 19/14

(52) U.S. Cl. CPC H04N 19/107; H04N 19/18; H04N 19/14; H04N 19/172; H04N 19/91

(57) ABSTRACT

An image encoding method comprises hybrid digital-analog (HDA) encoding a first image frame to generate first encoded data including a digital part and an analog part and inter-encoding a second image frame according to the digital part of the first encoded data to generate second encoded data.

### CROSS-REFERENCE TO RELATED APPLICATION

This application is a continuation of International Application No. PCT/CN2018/087089, filed May 16, 2018, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to information technology and, more particularly, to an image transmission scheme, an image encoding method, an image decoding method, an image transmission system, an encoder, a decoder, a transmitting terminal, a receiving terminal, and an unmanned aerial vehicle (UAV).

### BACKGROUND

In wireless image/video transmission systems, the transmission latency is a factor affecting smooth image transmission. Therefore, the size of each image frame obtained after compression is required to match with (or be lower than) the current channel capacity, such that a stable transmission latency is ensured and a smooth transmission is achieved.

In digital image transmission systems, the compression of an intra-frame (also referred to as I-frame) does not depend on any other frames, and thus the compression rate of the I-frame is low and the size of the encoded I-frame is large. If the I-frame is forced to reduce the size, the quality of the I-frame becomes poorer. Therefore, the problem that an I-frame is difficult to compress and difficult to match with the channel capacity is a long-standing problem in the image transmission field.

Hybrid digital-analog (HDA) transmission systems were introduced to tackle the challenge for matching the image frames with the channel capacity and lowering the transmission latency in the wireless transmission field. The quality of the received images changes with the change of the channel capacity in the HDA transmission systems, such that complex coding mode selection does not need to be performed. However, the conventional HDA transmission systems need higher air interface bandwidth and are less efficient than the pure digital image transmission systems. Some experiments have proved that the quality of the received images using the digital transmission is better than the quality of the received images using the conventional HDA transmission under the same bandwidth and channel environment.

### SUMMARY

In accordance with the disclosure, there is provided an image encoding method including hybrid digital-analog (HDA) encoding a first image frame to generate first encoded data including a digital part and an analog part and inter-encoding a second image frame according to the digital part of the first encoded data to generate second encoded data.

Also in accordance with the disclosure, there is provided an image decoding method including HDA decoding first encoded data to obtain a first image frame, the first encoded data including a digital part and an analog part and inter-decoding second encoded data according to the digital part of the first encoded data to obtain a second image frame.

Also in accordance with the disclosure, there is provided an encoder including a processor and a memory coupled to the processor and storing instructions. The processor is configured to hybrid digital-analog (HDA) encode a first image frame to generate first encoded data including a digital part and an analog part and inter-encode a second image frame using a reference frame reconstructed from the digital part of the first encoded data to generate second encoded data.

Also in accordance with the disclosure, there is provided a decoder including a processor and a memory coupled to the processor and storing instructions. The processor is configured to HDA-decode first encoded data to obtain a first image frame, the first encoded data including a digital part and an analog part and inter-decode second encoded data according to the digital part of the first encoded data to obtain a second image frame.

Also in accordance with the disclosure, there is provided an unmanned aerial vehicle (UAV) including a fuselage, a propulsion system coupled to the fuselage, an image acquiring device coupled to the fuselage, and a processor. The propulsion system includes one or more propellers, one or more motors, and an electronic governor. The image acquiring device is configured to acquire a first image frame and a second image frame. The processor is configured to encode the image by HDA encoding the first image frame to generate first encoded data including a digital part and an analog part and inter-encoding the second image frame using a reference frame reconstructed from the digital part of the first encoded data to generate second encoded data.

### BRIEF DESCRIPTION OF THE DRAWINGS

FIG. 1 is a schematic diagram showing an image transmission system according to exemplary embodiments of the disclosure.

FIG. 2 is a schematic diagram showing a transmitting terminal according to exemplary embodiments of the disclosure.

FIG. 3 is a schematic diagram showing an encoder according to exemplary embodiments of the disclosure.

FIG. 4 is a schematic diagram showing a receiving terminal according to exemplary embodiments of the disclosure.

FIG. 5 is a schematic diagram showing a decoder according to exemplary embodiments of the disclosure.

FIG. 6 is a schematic diagram showing an unmanned aerial vehicle (UAV) according to exemplary embodiments of the disclosure.

FIG. 7 schematically shows an image transmission scheme according to exemplary embodiments of the disclosure.

FIG. 8 is a flow chart showing an image encoding method according to exemplary embodiments of the disclosure.

FIG. 9 is a flow chart showing a hybrid digital-analog (HDA) encoding method according to exemplary embodiments of the disclosure.

FIG. 10 is a flow chart showing another HDA encoding method according to exemplary embodiments of the disclosure.

FIG. 11 is a flow chart showing an image decoding method according to exemplary embodiments of the disclosure.

FIG. 12 is a flow chart showing an HDA decoding method according to exemplary embodiments of the disclosure.

FIG. 13 is a flow chart showing another HDA decoding method according to exemplary embodiments of the disclosure.

### DETAILED DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts.

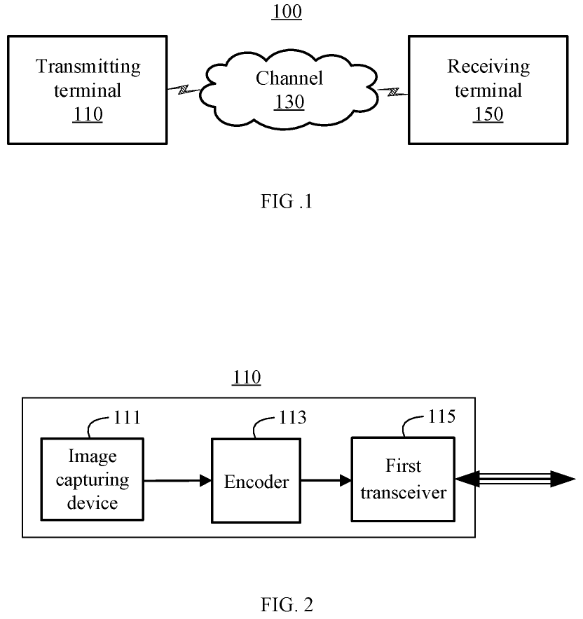

FIG. 1 is a schematic diagram showing an exemplary image transmission system 100 consistent with the disclosure. The image transmission system 100 includes a transmitting terminal 110 and a receiving terminal 150. The image transmission system 100 can perform an image transmission scheme consistent with the disclosure, such as one of the exemplary image transmission schemes described below. In some embodiments, the image transmission system 100 can also support one or more of a hybrid digital-analog (HDA) transmission scheme that adopts both analog coding and digital coding, such as wireless scalable video coding (WSVC), a pure digital transmission scheme that only uses digital coding, such as H.264, or a pure analog transmission scheme that only uses analog coding which linearly transforms the image without quantization, entropy encoding, and forward error correction (FEC), such as SoftCast. The images may be still images, e.g., pictures, and/or moving images, e.g., videos. Hereinafter, the term “image” is used to refer to either a still image or a moving image and the term “coding” is used to refer to both encoding and decoding operations.

As shown in FIG. 1, the transmitting terminal 110 is configured to transmit data to the receiving terminal 150 over a transmission channel 130. The data can be obtained by encoding images and the data can be also referred to as encoded data. In some embodiments, the encoded data can include at least a digital part and an analog part. For example, at least one image can be partially subject to digital encoding to obtain the digital part of the encoded data and can be partially subject to analog encoding to obtain the analog part of the encoded data.

In some embodiments, the transmitting terminal 110 can be configured to capture images and perform an image encoding method consistent with the disclosure, such as one of the exemplary image encoding methods described below, on the images to generate the encoded data. The receiving terminal 150 can be configured to receive the encoded data and perform an image decoding method consistent with the disclosure, such as one of the exemplary image decoding methods described below, on the encoded data to recover the images.

In some embodiments, the transmitting terminal 110 can be integrated in a mobile object, such as an unmanned aerial vehicle (UAV), a driverless car, a mobile robot, a driverless boat, a submarine, a spacecraft, a satellite, or the like. In some other embodiments, the transmitting terminal 110 can be a hosted payload carried by the mobile object that operates independently but may share the power supply of the mobile object.

In some embodiments, the receiving terminal 150 can be a remote controller or a terminal device with an application (app) that can control the transmitting terminal 110 or the mobile object in which the transmitting terminal 110 is integrated, such as a smartphone, a tablet, a game device, or the like. In some other embodiments, the receiving terminal 150 can be provided in another mobile object, such as a UAV, a driverless car, a mobile robot, a driverless boat, a submarine, a spacecraft, a satellite, or the like. The receiving terminal 150 and the mobile object can be separate parts or can be integrated together.

The transmission channel 130 can include a wireless channel and/or a wired channel. The transmission channel 130 can use any type of physical transmission medium, such as cable (e.g., twisted-pair wire or fiber-optic cable), air, water, space, or any combination of the above media. For example, if the transmitting terminal 110 is integrated in a UAV and the receiving terminal 150 is a remote controller, the data can be transmitted over air. If the transmitting terminal 110 is a hosted payload carried by a commercial satellite and the receiving terminal 150 is integrated in a ground station, the data can be transmitted over space and air. If the transmitting terminal 110 is a hosted payload carried by a submarine and the receiving terminal 150 is integrated in a driverless boat, the data can be transmitted over water.

FIG. 2 is a schematic diagram showing an exemplary transmitting terminal 110 consistent with the disclosure. The transmitting terminal 110 includes an image capturing device 111, an encoder 113, and a first transceiver 115. The encoder 113 is coupled to the image capturing device 111 and the first transceiver 115.

The image capturing device 111 includes an image sensor and a lens or a lens set, and is configured to capture images. The image sensor can be, for example, an opto-electronic sensor, such as a charge-coupled device (CCD) sensor, a complementary metal-oxide-semiconductor (CMOS) sensor, or the like. The image capturing device 111 is further configured to send the captured images to the encoder 113 for encoding. In some embodiments, the image capturing device 111 can include a memory for storing, either temporarily or permanently, the captured images.

The encoder 113 is configured to receive the images captured by the image capturing device 111 and encode the images to generate encoded data. The encoder 113 can support any suitable digital coding standard, such as Moving Picture Experts Group (MPEG, e.g., MPEG-1, MPEG-2, or MPEG-4), H.26x (e.g., H.261, H.262, H.263, or H.264), or the like, any suitable analog coding standard, such as SoftCast or the like, and/or any suitable HDA coding standard, such as WSVC or the like.

In some embodiments, the encoder 113 can perform HDA encoding on at least one of the images according to any suitable HDA coding standard and perform digital encoding on the other images according to any suitable digital coding standard. That is, the at least one of the images that is subjected to the HDA encoding can be partially subject to digital encoding to obtain the digital part of the encoded data and can be partially subject to analog encoding to obtain the analog part of the encoded data. In some embodiments, digital encoding may include generating a compressed bit stream from an image using quantization and entropy encoding; while analog encoding may include linearly transforming the image without quantization or entropy encoding. In some embodiments, the at least one of the images that are HDA-encoded is an intra-frame (also referred to as I-frame that is encoded based on information only in the image frame itself), and the images other than the I-frame can be inter-encoded. That is, the images other than the I-frame can be inter-frames (also referred to as P-frames that are encoded with reference to information from one or more different image frames).

An image frame may refer to a complete image. Hereinafter, the terms “frame”, “image,” and “image frame” are used interchangeably.

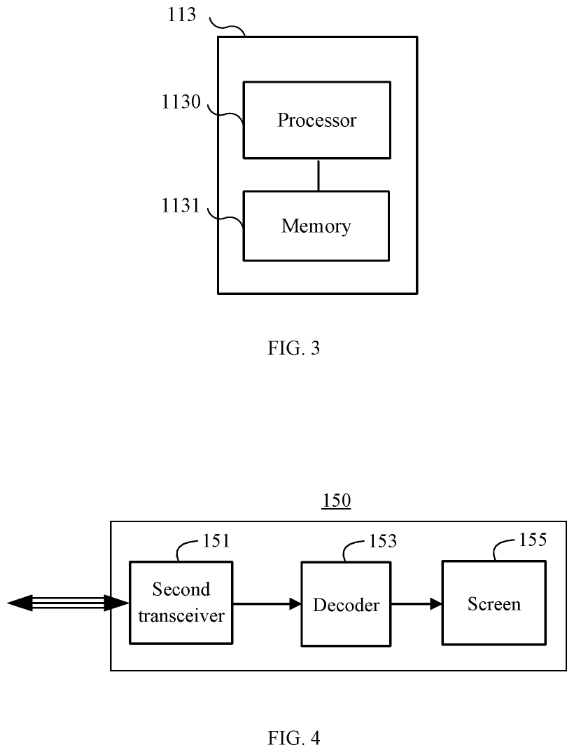

FIG. 3 is a schematic diagram showing an exemplary encoder 113 consistent with the disclosure. As shown in FIG. 3, the encoder 113 includes a processor 1130 and a memory 1131. The processor 1130 can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The memory 1131 stores computer program codes that, when executed by the processor 1130, cause the processor 1130 to perform an image encoding method consistent with the disclosure, such as one of the exemplary image encoding methods described below. In some embodiments, the memory 1131 can also store the images captured by the image capturing device 111 and the encoded data. The memory 1131 can include a non-transitory computer-readable storage medium, such as a random-access memory (RAM), a read only memory, a flash memory, a volatile memory, a hard disk storage, or an optical medium.

Referring again to FIG. 2, the first transceiver 115 may include a transmitter and a receiver, and can be configured to have a two-way communication capability, i.e., can both transmit and receive data. In some embodiments, the transmitter and the receiver may share common circuitry. In some other embodiments, the transmitter and the receiver may be separate parts sharing a single housing.

The first transceiver 115 is configured to obtain the encoded data from the encoder 113 and transmit the encoded data to the receiving terminal 150 over the transmission channel 130. In some other embodiments, the first transceiver 115 can be further configured to receive, for example, the feedback information (e.g., channel information) and/or control commands for controlling the transmitting terminal 110, from the receiving terminal 150 over the wireless channel 130. The first transceiver 115 may work in any suitable frequency band, for example, microwave band, millimeter-wave band, centimeter-wave band, optical wave band, or the like.

According to the disclosure, the image capturing device 111, the encoder 113, and the first transceiver 115 can be separate devices, or any two or more of them can be integrated in one device. In some embodiments, the image capturing device 111, the encoder 113, and the first transceiver 115 are separate devices that can be connected or coupled to each other. For example, the image capturing device 111 can be a camera, a camcorder, or a smartphone having a camera function. The encoder 113 can be an independent device including a processor and a memory as shown in FIG. 3 and is coupled to the image capturing device 111 and the first transceiver 115 through wired or wireless means. The first transceiver 115 can be an independent device combining transmitter/receiver in a single package.

In some other embodiments, any two of the image capturing device 111, the encoder 113, and the first transceiver 115 can be integrated in a same device. For example, the image capturing device 111 and the encoder 113 may be parts of a same device including a camera, a lens, a processor, and a memory. The processor can be any type of processor and the memory can be any type of memory. The disclosure is not limited here. In this example, the device can further include an electrical interface (either wired or wireless) for coupling to the first transceiver 115.

In some other embodiments, the image capturing device 111, the encoder 113, and the first transceiver 115 can be integrated in a same electronic device. For example, the image capturing device 111 may include an image sensor and a lens or a lens set of the electronic device. The encoder 113 may be implemented by a single-chip encoder, a single-chip codec, an image processor, an image processing engine, or the like, which is integrated in the electronic device. The first transceiver 115 may be implemented by an integrated circuit, a chip, or a chipset that is integrated in the electronic device. For example, the electronic device may be a smartphone having a built-in camera and a motherboard that integrates the encoder 113 and the first transceiver 115.

FIG. 4 is a schematic diagram showing an exemplary receiving terminal 150 consistent with the disclosure. The receiving terminal 150 includes a second transceiver 151, a decoder 153, and a screen 155. The decoder 153 is coupled to the second transceiver 151 and the screen 155. In some embodiments, the second transceiver 151 can be also coupled to the screen 155.

The second transceiver 151 is configured to receive the encoded data from the transmitting terminal 110 over the wireless channel 130 and send the encoded data to the decoder 153 for decoding. In some other embodiments, the second transceiver 151 is further configured to transmit, for example, feedback information (e.g., channel information) and/or control commands for controlling the transmitting terminal 110, to the transmitting terminal 110 over the wireless channel 130.

The second transceiver 151 can include a transmitter and a receiver. The second transceiver 151 can be configured to have a two-way communications capability. In some embodiments, the transmitter and the receiver may share common circuitry. In some other embodiments, the transmitter and the receiver may be separate parts sharing a single housing. The second transceiver 151 can work in a same frequency band as that used in the first transceiver 115 of the transmitting terminal 110. For example, if the first transceiver 115 uses the microwave band, the second transceiver 151 works in the corresponding microwave band. If the first transceiver 115 uses optical wave band, the second transceiver 151 works in the corresponding optical wave band.

The decoder 153 is configured to obtain the encoded data from the second transceiver 151 and decode the encoded data to recover the images captured by the image capturing device 111. The decoder 153 can support any digital coding standard that is employed in the encoder 113, any analog coding standard that is employed in the encoder 113, and/or any HDA coding standard that is employed in the encoder 113.

In some embodiments, the at least one of images subject to the HDA encoding, i.e., partial digital encoding and partial analog encoding, in the encoder 113 of the transmitting terminal 110 can be recovered by the decoder 153, according to the HDA coding standard that is employed by the encoder 113 of the transmitting terminal 110. The images subject to the digital encoding in the encoder 113 of the transmitting terminal 110 can be recovered by the decoder 153, according to the digital coding standard that is employed by the encoder 113 of the transmitting terminal 110.

In some embodiments, the decoder 153 can decode the I-frames using the corresponding HDA coding standard and decode the P-frames using the corresponding digital coding standard. In some embodiments, the decoder 153 can inter-decode the P-frames using the corresponding digital coding standard.

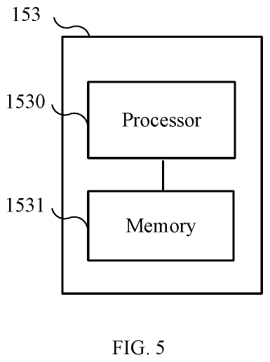

FIG. 5 is a schematic diagram showing an exemplary decoder 153 consistent with the disclosure. As shown in FIG. 5, the decoder 153 includes a processor 1530 and a memory 1531. The processor 1530 can include any suitable hardware processor, such as a microprocessor, a micro-controller, a CPU, a NP, a DSP, an ASIC, an FPGA, or another programmable logic device, discrete gate or transistor logic device, discrete hardware component. The memory 1531 stores computer program codes that, when executed by the processor, perform an image decoding method consistent with the disclosure, such as one of the exemplary image decoding methods described below. In some embodiments, the memory 1531 can also store data. For example, the memory 1531 can store the received encoded data, recovered images, or the like. The memory 1531 can include a non-transitory computer-readable storage medium, such as a RAM, a read only memory, a flash memory, a volatile memory, a hard disk storage, or an optical medium.

Referring again to FIG. 4, the screen 155 is configured to display the recovered image and/or other information, for example, data and time information about when the images are received. The recovered image can occupy a portion of the screen 155 or the entire screen 155.

In some embodiments, the screen 155 can include a touch panel for receiving a user input. The user can touch the screen 155 with an external object, such as a finger of the user or a stylus. In some embodiments, the user can adjust image parameters, such as brightness, contrast, saturation, and/or the like, by touching the screen 155. For example, the user can scroll vertically on the image to select a parameter, then swipe horizontally to change the value of the parameter.

In some embodiments, the user can input the control command for controlling the transmitting terminal 110 by touching the screen 155. For example, the user can input a control command for controlling the image capturing device 111 of the transmitting terminal 110 to start or stop capturing images. As another example, the user can input a control command for selecting the coding technique used in the encoder 113 of the transmitting terminal 110. The screen 155 can also be configured to send the control command inputted by the user to the second transceiver 151, such that the second transceiver 151 can transmit the control command to the transmitting terminal 110.

According to the disclosure, the second transceiver 151, the decoder 153, and the screen 155, can be separate devices, or any two or more of them can be integrated in one device. In some embodiments, the second transceiver 151, the decoder 153, and the screen 155 are separate devices that can be connected or coupled to each other. For example, the second transceiver 151 can be an independent device combining transmitter/receiver in a single package. The decoder 153 can be an independent device including the processor and the memory as shown in FIG. 5 and is coupled to the second transceiver 151 and the screen 155. The screen 155 can be a display device coupled to the second transceiver 151 and the decoder 153 through wired or wireless means.

In some other embodiments, any two of the second transceiver 151, the decoder 153, and the screen 155 can be integrated in a same device. For example, the decoder 153 and the screen 155 may be parts of a same device including a processor, a memory, and a screen. The processor can be any type of processor and the memory can be any type of memory. The disclosure is not limited here. In this example, the device can further include an electrical interface (either wired or wireless) for coupling to the second transceiver 151.

In some other embodiments, the second transceiver 151, the decoder 153, and the screen 155 are integrated in a same electronic device. For example, the second transceiver 151 may be implemented by an integrated circuit, a chip, or a chipset that is integrated in the electronic device. The decoder 153 may be implemented by a single-chip decoder, a single-chip codec, an image processor, an image processing engine, or the like, which is integrated in the electronic device. For example, the electronic device may be a tablet having a screen and a motherboard that integrates the second transceiver 151 and the decoder 153.

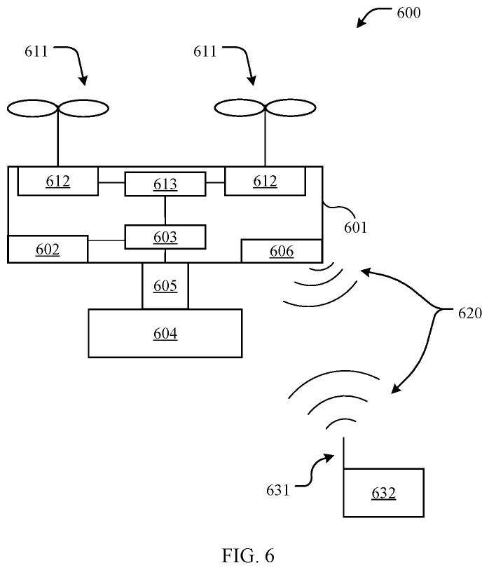

FIG. 6 is a schematic diagram showing an exemplary unmanned aerial vehicle (UAV) 600 consistent with the disclosure. As shown in FIG. 6, the UAV 600 includes a fuselage 601, a propulsion system, a navigation system 602, a control system 603, an image acquiring device 604, a gimbal 605, and a communication system 606. The propulsion system includes one or more propellers 611, one or more motors 612, and an electronic governor 613. The propulsion system can be provided at the fuselage 601 for providing power for flight.

The navigation system 602 can include one or more of motion sensors (e.g., accelerometers), rotation sensors (e.g., gyroscopes), magnetic sensors (magnetometers), or the like. The navigation system 602 can be configured to detect a speed, an acceleration, and/or attitude parameters (such as pitch angle, roll angle, yaw angle, and/or the like) of the UAV 600, attitude parameters of the image acquiring device 604, and/or attitude parameters of the gimbal 605. The navigation system 602 can be provided inside or on the fuselage 601 of the UAV 600.

The control system 603 is coupled to the navigation system 602, the electronic governor 613, and the gimbal 605. The control system 603 can be configured to control a flight attitude of the UAV 600 and/or a rotation of the gimbal 604 according the attitude parameters obtained by the navigation system 602. In some embodiments, the control system 603 can be coupled to the image acquiring device 604 and configured to control an attitude, such as a rotation, of the image acquiring device 604. The control system 603 can be provided inside the fuselage 601 of the UAV 600.

The image acquiring device 604 is connected to the fuselage 601 of the UAV 600 via the gimbal 605. In some embodiments, the image acquiring device 604 can be directly connected to the fuselage 601 without the need for the gimbal 605. The image acquiring device 604 can be provided below or above the fuselage 601 of the UAV 600. The image acquiring device 604 can include an image sensor and a lens or a lens set. The image acquiring device 604 is configured to capture the images. The image sensor can include, for example, an opto-electronic sensor, such as a charge-coupled device (CCD) sensor, a complementary metal-oxide-semiconductor (CMOS) sensor, or the like. The image acquiring device 604 can rotate along with the rotation of the gimbal 605, such that the image acquiring device 604 can perform a tracking shooting on a target object.

In some embodiments, the image acquiring device 604 can include an encoder (not shown in FIG. 6). The encoder is configured to encode the images captured by the image sensor to generate encoded data. In some embodiments, the encoder can perform an image encoding method consistent with the disclosure, such as one of the exemplary image encoding methods described below, on the images to generate the encoded data. The encoded data can include digital parts and/or analog parts. In some other embodiments, the encoder can be an independent device provided inside the fuselage 601 of the UAV 600 and can be coupled to the image acquiring device 604 to receive the images captured by the image sensor. The encoder can be similar to the encoder 113 described above.

The communication system 606 can include a receiver and/or a transmitter. The receiver can be configured to receive wireless signals 620 transmitted by an antenna 631 of a ground station 632, and the communication system 606 can also send the wireless signals 620 (such as the encoded data, status information of the UAV, or the like) to the ground station 632. The communication system 606 can be similar to the first transceiver 115 described above. The communication system 606 can be provided inside or on the fuselage 601 of the UAV 600.

Exemplary image transmission scheme consistent with the disclosure will be described in more detail below. An image transmission scheme consistent with the disclosure can be implemented in an image transmission system consistent with the disclosure, such as the image transmission system 100 described above.

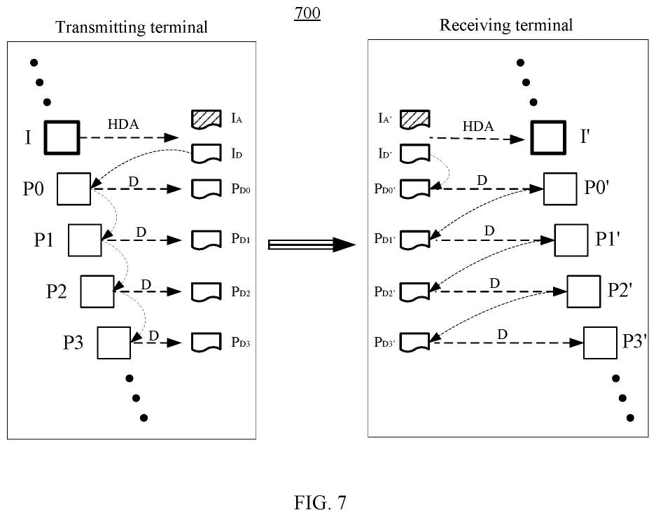

FIG. 7 schematically shows an image transmission scheme 700 consistent with the disclosure. According to the image transmission scheme 700, an image transmission system, such as the image transmission system 100 described above, can encode and decode I-frames according to an HDA coding standard, and encode and decode P-frames according to a digital coding standard. That is, both analog coding operation and digital coding operation can be performed on the I-frames and only digital coding operation may be performed on the P-frames. Since the HDA coding technique integrates the advantages of digital coding and analog coding (e.g., graceful degradation with channels), the problem that the I-frames are difficult to compress and difficult to match with the channel capacity can be solved. For example, digital coding can have a high coding efficiency. On the other hand, analog coding can, e.g., have a graceful degradation with channels. That is, a degradation of quality of a recovered image obtained by analog coding can be almost proportional to a channel signal-to-noise ratio (SNR), as opposed to a recovered image obtained by digital coding whose image quality may degrade dramatically when the channel SNR increases above a certain threshold. Furthermore, because only the digital coding is performed on the P-frames, the problems of insufficient bandwidth and limited transmission quality in the conventional HDA transmission systems, which apply the HDA coding on all of the frames, can be solved.

As shown in FIG. 7, at a transmitting terminal consistent with the disclosure, such as the transmitting terminal 110 described above, an image frame to be encoded as the I-frame (denoted as I in FIG. 7) is encoded using the HDA coding standard. That is, the image frame I is partially digital-encoded to generate a digital part (denoted as ID in FIG. 7) of the encoded data corresponding to the image frame I and partially analog-encoded to generate an analog part (denoted as IA in FIG. 7) of the encoded data corresponding to the image frame I. The digital encoding can include intra-encoding, i.e., encoding using only information in the image frame I. In some embodiments, the digital part ID of the encoded data corresponding to the image frame I can be generated from low frequency components of the image frame I, and the analog part IA of the encoded data corresponding to the image frame I can be generated from high frequency components of the image frame I.

The image frame (denoted as P0 in FIG. 7) immediately after the image frame I is inter-encoded as a P-frame according to the digital part ID of the encoded data corresponding to the image frame I to generate the encoded data (denoted as Pro) in the form of a bitstream. That is, the image frame P0 can be inter-encoded with reference to a reconstructed frame reconstructed from the digital part ID of the encoded data corresponding to the image frame I to generate the P-frame.

Other image frames (denoted as P1, P2, P3, . . . in FIG. 7) after the image frame P0 and between two I-frames can be inter-encoded as P-frames to generate a plurality of bitstreams (denoted as P_{D1}, P_{D2}, P_{D3}, . . . in FIG. 7). In some embodiments, the reference frame for encoding a P-frame other than P0 can be a past frame (a neighboring frame that was obtained before the P-frame) of the P-frame. In some other embodiments, a P-frame other than P0 can be encoded with reference to multiple reference frames.

The encoded data I_{A}, I_{D}, P_{D0}, P_{D1}, P_{D2}, P_{D3}, . . . can be transmitted by the transmitting terminal through a transmission channel, such as the transmission channel 130 described above, and received by a receiving terminal consistent with the disclosure, such as the receiving terminal 150 described above. The corresponding received encoded data are denoted as I_{A′}, I_{D′}, P_{D0′}, P_{D1′}, P_{D2′}, P_{D3′}, . . . , respectively in FIG. 7. In some embodiments, the received encoded data I_{A′}, I_{D′}, P_{D0′}, P_{D1′}, P_{D2′}, P_{D3′}, . . . may be identical as the corresponding encoded data I_{A}, I_{D}, P_{D0}, P_{D1}, P_{D2}, P_{D3}, . . . , respectively. In some embodiments, the received encoded data I_{A′}, I_{D′}, P_{D0′}, P_{D1′}, P_{D2′}, P_{D3′}, . . . may be different from the corresponding encoded data I_{A}, I_{D}, P_{D0}, P_{D1}, P_{D2}, P_{D3}, . . . due to, e.g., transmission loss.

In some embodiments, the received digital part I_{D′} and the received analog part I_{A′} received at the receiving terminal can be decoded using the HDA coding standard to obtain a recovered image frame I′ corresponding to the image frame I. That is, the image frame I can be recovered as the recovered image frame I′ by intra-decoding the received digital part I_{D′} and analog-decoding the received analog part I_{A′}. For example, the low frequency components of the recovered image frame I′ can be obtained from the received digital part I_{D′} and the high frequency components of the recovered image frame I′ can be obtained from the received analog part I_{A′}.

The bitstream P_{D0′} received immediately after the received digital part I_{D′} and the received analog part I_{A′} corresponding to the image frame I can be inter-decoded according to the received digital part I_{D′} corresponding to the image frame I to obtain a recovered image frame P0′ corresponding to the image frame P0. That is, the bitstream P_{D0′} can be inter-decoded with reference to a decoded image recovered from the received digital part I_{D′} corresponding to the image frame I.

The other bitstreams P_{D1′}, P_{D2′}, P_{D3′}, . . . received after the bitstream P_{D0′} and between two I-frames can be inter-decoded using the digital coding standard. In some embodiments, the reference frame for a bitstream other than P_{D0′} can be a previously decoded frame. In some other embodiments, the reference frame for a bitstream other than P_{D0′} can include multiple previously decoded frames.

The HDA coding standard, the digital coding standard, and/or the analog coding standard used in the receiving terminal can be the same as those used in the transmitting terminal. In the transmitting terminal, the encoding operations of the HDA coding standard, the digital coding standard, and/or the analog coding standard are performed. In the receiving terminal, the decoding operations of the HDA coding standard, the digital coding standard, and/or the analog coding standard are performed. The HDA coding standard can be any type of HDA coding standard; the digital coding standard can be any type of digital coding standard; and the analog coding standard can be any type of analog coding standard. The disclosure is not limited here. The selection of the coding standard can be based on the actual needs.

Exemplary image encoding methods consistent with the disclosure will be described in more detail below. An image encoding method consistent with the disclosure can be implemented in a transmitting terminal consistent with the disclosure, such as the transmitting terminal 110 of the image transmission system 100 described above.

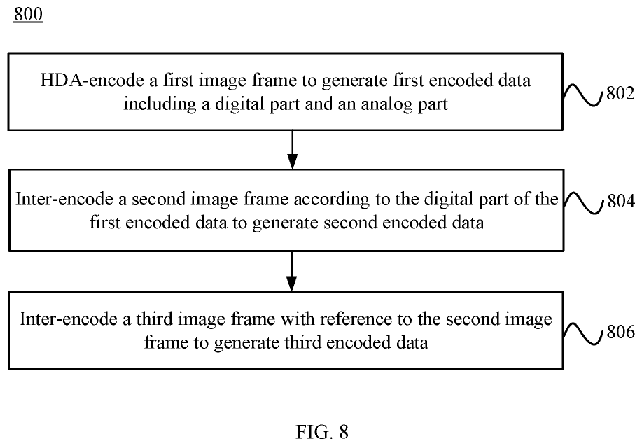

FIG. 8 is a flow chart showing an exemplary image encoding method 800 consistent with the disclosure. According to the image encoding method 800, an encoder of the transmitting terminal, such as the encoder 113 of the transmitting terminal 110 described above, can encode I-frames according to the HDA coding standard and encode P-frames according to the digital coding standard. That is, both analog encoding operation and digital encoding operation are performed on the I-frames and only digital encoding operation is performed on the P-frames. Since the HDA coding technique integrates the advantages of digital coding (e.g., high-coding efficiency) and analog coding (e.g., graceful degradation with channels), the problem that the I-frames are difficult to compress and difficult to match with the channel capacity can be solved. Furthermore, because only the digital coding is performed on the P-frames, the problems of insufficient bandwidth and limited transmission quality in the conventional HDA transmission systems, which apply the HDA coding on all of the frames, can be solved.

As shown in FIG. 8, at 802, a first image frame is HDA encoded to generate first encoded data including a digital part and an analog part. That is, the first image frame is partially digital-encoded, e.g., intra-encoded, to generate the digital part of the first encoded data and partially analog-encoded to generate the analog part of the first encoded data. The first image frame is an I-frame. Any suitable HDA coding standard can be adopted here. The disclosure is not limited here.

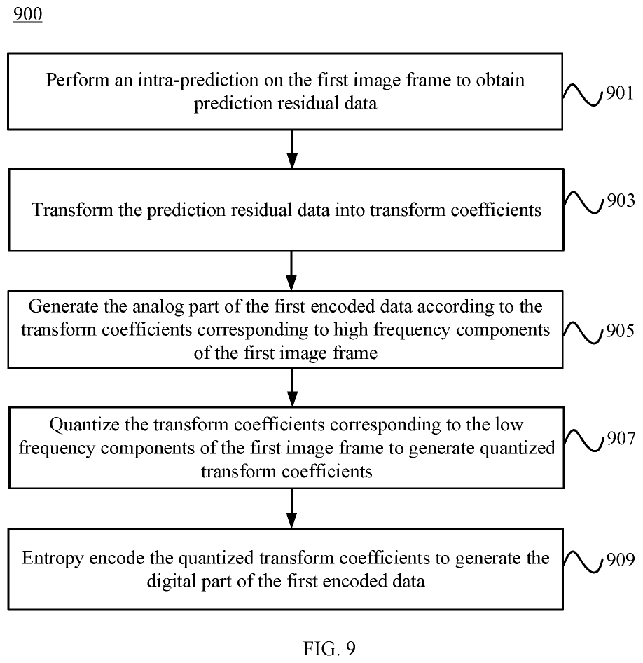

FIG. 9 is a flow chart showing an exemplary HDA encoding method 900 consistent with the disclosure. According to the HDA encoding method 900, the digital part of the first encoded data can be generated from the low frequency components of the first image frame and the analog part of the first encoded data can be generated from the high frequency components of the first image frame. As such, the advantage of digital transmission can be utilized to ensure the low frequency components of the first image frame can be correctly recovered in a receiving terminal, such as the receiving terminal 150 described above. The high frequency components of the first image frame can be gracefully degraded with the transmission channel. The problem that the I-frames are difficult to compress and difficult to match with the channel capacity can be solved.

Here, a whole frame or a block of the frame, such as a macroblock (MB), a sub-block, or the like can be encoded. The block of the first image frame refers to a portion of the first image frame, which includes a plurality of pixels of the first image frame.

As shown in FIG. 9, at 901, an intra-prediction is performed on the first image frame to obtain prediction residual data. Due to the two-dimensional (2D) nature of the first image frame, the prediction residual data can usually be arranged in a 2D form as a residual array. The residual array can include, e.g., a residual frame for the entire first image frame or a residual block for a block of the first image frame.

The prediction residual data can be generated by subtracting intra-predicted data of the first image frame from the first image frame. The intra-predicted data of the first image frame can be generated by performing intra-prediction on the first image frame using one of a plurality of intra-prediction modes. Similarly, the intra-predicted data can also be in a 2D form. In some embodiments, the plurality of intra-prediction modes can be those supported by the digital coding standard that is employed. The one of the plurality of intra-prediction modes can be one that is most suitable for the first image frame, which is also referred to as a best intra-prediction mode. For example, the digital coding standard H.264 supports nine intra-prediction modes for luminance 4×4 and 8×8 blocks, including 8 directional modes and one intra direct component (DC) mode that is a non-directional mode. In this situation, the best intra-prediction mode for the first image frame can be selected from all intra-prediction modes supported by H.264 as described above. Any suitable intra-prediction mode selection technique can be used here. For example, a Rate-Distortion Optimization (RDO) technique can be used to select the best intra-prediction mode which has a least rate-distortion (RD) cost.

The intra-predicted data can be subtracted from the first image frame to generate the prediction residual data.

At 903, the prediction residual data is transformed into transform coefficients. That is, the prediction residual data is transformed from the spatial domain into a representation in the spatial frequency domain for more efficient quantization and data compression. In the spatial frequency domain, the prediction residual data can be expressed in terms of a plurality of frequency-domain components, such as a plurality of sine and/or cosine components. Coefficients associated with the frequency-domain components in the frequency-domain expression are also referred to as the transform coefficients. Similarly, the transform coefficients can also be arranged in a 2D form. Any suitable transform algorithm can be used to obtain the transform coefficients, such as discrete cosine transform (DCT), discrete wavelet transform (DWT), time-frequency analysis, Fourier transform, lapped transform, or the like. For example, in H.264, a residual block can be transformed using a 4×4 or 8×8 integer transform derived from the DCT.

At 905, the analog part of the first encoded data is generated according to the transform coefficients corresponding to high frequency components of the first image frame.

In some embodiments, the analog part of the first encoded data can include the transform coefficients corresponding to the high frequency components of the first image frame.

In some embodiments, the high frequency components that almost do not contribute to information in the first image frame, i.e., the high frequency components that have very small transform coefficients, such as the high frequency components having transform coefficients smaller than a threshold value, can be discarded. That is, the analog part of the first encoded data can exclude the transform coefficients corresponding to the high frequency components that do not contribute to information in the first image frame. For example, zero- and near-zero-value transform components can be discard. That is, the transform coefficients having a zero or near-zero value can be excluded from the analog part of the first encoded data.

In some embodiments, nearby transform components can be grouped in one chunk and a decision can be made for all transform components in a chunk. That is, all transform components in one chunk can be retained or discarded together. Making one decision per chunk allows reducing an amount of metadata to a decoder of the receiving terminal, such as the decoder 153 of the receiving terminal 150 described above, for locating, e.g., the discarded transform components.

At 907, the transform coefficients corresponding to the low frequency components of the first image frame are quantized to generate quantized transform coefficients. In some embodiments, the transform coefficients corresponding to the low frequency components are divided by a quantization step size (Qₛₜₑₚ) to obtain the quantized transform coefficients. A larger value of the quantization step size results in a higher compression at the expense of a poorer image quality. Similarly, the quantized transform coefficients can be also in a 2D form.

At 909, the quantized transform coefficients are entropy encoded to generate the digital part of the first encoded data. That is, the quantized transform coefficients are converted into binary codes, i.e., the digital part of the first encoded data. Any suitable entropy encoding technique may be used, such as Huffman coding, Unary coding, Arithmetic coding, Shannon-Fano coding, Elias gamma coding, Tunstall coding, Golomb coding, Ricde coding, Shannon coding, Range encoding, universal coding, exponential-Golomb coding, Fibonacci coding, or the like. In some embodiments, the quantized transform coefficients may be reordered before being subject to the entropy encoding.

In some embodiments, the prediction process at 901 can be omitted. That is, the first image frame can be directly transformed to obtain the transform coefficients without prediction.

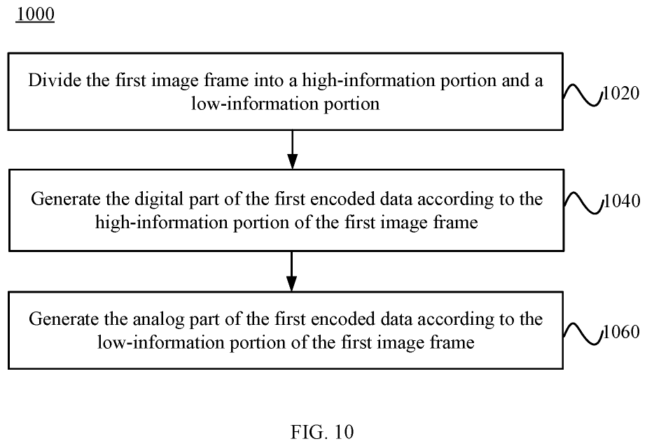

FIG. 10 is a flow chart showing another exemplary HDA encoding method 1000 consistent with the disclosure. According to the HDA encoding method 1000, the digital part of the first encoded data can be generated from the blocks of the first image frame containing large amount of information and the analog part of the first encoded data can be generated from the blocks of the first image frame containing small amount of information. As such, the advantage of digital transmission can be utilized to ensure the important image data can be correctly recovered in a receiving terminal, such as the receiving terminal 150 described above. The less important image data can be gracefully degraded with the transmission channel. The problem that the I-frames are difficult to compress and difficult to match with the channel capacity can be solved.

As shown in FIG. 10, at 1020, the first image frame is divided into a high-information portion and a low-information portion.

The first image frame can be divided into a plurality of blocks. The number and size of the blocks can be determined according the actual needs. The amounts of information in the plurality of blocks can be calculated and characterized by, for example, information entropies of the plurality of blocks. Generally, a larger entropy value corresponds to a larger amount of information and a smaller entropy value corresponds to a less amount of information. Any parameters that can reflect the amounts of information in the plurality of blocks can be used here. The disclosure is not limited here. A block can either belong to the high-information portion of the first image frame or the low-information portion of the first image frame, depending on the amount of information of the block. That is, the high-information portion of the first image frame refers to a portion of the first image frame that contains blocks with large amounts of information, while the low-information portion of the first image frame refers to a portion of the first image frame that contains blocks with small amounts of information. For example, a block having the amount of information less than or equal to a threshold can belong to the low-information portion of the first image frame and a block having the amount of information greater than the threshold can belong to the high-information portion of the first image frame. The threshold can be determined according to at least one of a channel bandwidth, a bit rate, or a resolution of the first image frame.

At 1040, the digital part of the first encoded data is generated according to the high-information portion of the first image frame. That is, the high-information portion of the first image frame is digital-encoded, e.g., intra-encoded, to generate the digital part of the first encoded data.

Digital-encoding, e.g., intra-encoding, the high-information portion of the first image frame can be accomplished according to any suitable digital coding standard, such as MPEG-x (e.g., MPEG-1, MPEG-2, or MPEG-4), H.26x (e.g., H.261, H.262, H.263, or H.264), or another format. The disclosure is not limited here.

Intra-encoding the high-information portion of the first image frame can include applying intra-prediction, transform, quantization, and entropy encoding to the high-information portion of the first image frame. In some embodiments, the high-information portion of the first image frame can be processed/encoded block by block. The intra-prediction, transform, quantization, and entropy encoding processes for intra-encoding the high-information portion of the first image frame are similar to those processes in FIG. 9, and thus detailed description thereof is omitted here.

At 1060, the analog part of the first encoded data is generated according to the low-information portion of the first image frame. That is, the low-information portion of the first image frame can be analog-encoded to generate the analog part of the first encoded data.

Analog-encoding the low-information portion of the first image frame can be accomplished according to any suitable analog coding standard, such as SoftCast, line-cast, Realcast, or the like. The disclosure is not limited here.

In some embodiments, analog-encoding the low-information portion of the first image frame can include generating the analog part of the first encoded data according to the transform coefficients of the low-information portion of the first image frame. Any suitable transform algorithm can be used to obtain the transform coefficients, such as, for example, DCT, DWT, three dimensional DCT (3D-DCT), 2D-DWT+DCT, or the like. For example, in the DCT transform, the low-information portion of the first image frame can be expressed in terms of a plurality DCT components. Coefficients associated with the DCT components can form the analog part of the first encoded data and can be directly transmitted without quantization and entropy encoding.

In some embodiments, analog-encoding the low-information portion of the first image frame can also include discarding the frequency components, e.g., the DCT components, that do not contribute to the information in the low-information portion of the first image frame. For example, zero- or near-zero-value DCT components can be discarded.

In some embodiments, the nearby DCT components can be grouped in one chunk and a decision can be made for all DCT components in a chunk. That is, all DCT components in the chunk can be retained or discarded together. As noted above, making one decision per chunk allows reducing an amount of metadata to a decoder of the receiving terminal, such as the decoder 153 of receiving terminal 150 described above, for locating, e.g., the discarded DCT components.

Referring again to FIG. 8, at 804, a second image frame is inter-encoded according to the digital part of the first encoded data to generate second encoded data. In some embodiments, the second image frame is inter-encoded with reference to a reconstructed frame reconstructed from the digital part of the first encoded data. The second image frame can be an image frame immediately after the first image frame. The second image frame can be a P-frame.

Inter-encoding the second image frame can be accomplished according to any suitable digital coding standard, such as MPEG-x (e.g., MPEG-1, MPEG-2, or MPEG-4), H.26x (e.g., H.261, H.262, H.263, or H.264), or another standard.

Inter-encoding the second image frame can include applying inter-prediction, transform, quantization, and entropy encoding to the second image frame.

In some embodiments, applying the inter-prediction process on the second image frame can include generating inter-predicted data of the second image frame with reference to the reconstructed frame of the digital part of the first image frame using one of a plurality of inter-prediction modes. In some embodiments, the plurality of inter-prediction modes can be those supported by the digital coding standard that is employed. The one of the plurality of inter-prediction modes can be one that is most suitable for the second image frame, which is also referred to as a best inter-prediction mode.

For example, if H.264 is employed, the inter-prediction can use one of a plurality of block sizes, e.g., a size of 16×16, a size of 16×8, a size of 8×16, a size of 8×8, a size of 8×4, a size of 4×8, and a size of 4×4. The inter-prediction in H.264 also includes a block matching process, during which a best matching block is identified as a reference block for the purposes of motion estimation. The best matching block for a block of the second image frame can be a block in the reconstructed frame of the digital part of the first image frame that is most similar to the block of the second image frame. That is, there is a smallest prediction error between the best matching block and the block of the second image frame. Any suitable block matching algorithm can be employed, such as exhaustive search, optimized hierarchical block matching (OHBM), three step search, two dimensional logarithmic search (TDLS), simple and efficient search, four step search, diamond search (DS), adaptive rood pattern search (ARPS), or the like.

In this situation, the best inter-prediction mode for the second image frame can be selected from all possible combinations of the inter-prediction modes supported by H.264 as described above. Any suitable inter-prediction mode selection technique can be used here. For example, an RDO technique selects the best inter-prediction mode which has a least RD cost.

The inter-predicted data can be subtracted from the second image frame to generate prediction residual data.

The transform, quantization, and entropy encoding processes for inter-encoding the second image frame are similar to those described above in connection with FIG. 9, and thus detailed description thereof is omitted here.

Inter-encoding the second image frame can also include generating the reconstructed frame by reconstructing the digital part of the first encoded data as the reference frame for encoding the second image frame. Generating the reconstructed frame of the digital part of the first encoded data can include applying inverse quantization, inverse transform, and inter-prediction on the quantized transform coefficients corresponding to the digital part of the first encoded data. The inverse quantization, inverse transform, and inter-prediction processes are similar to those in the decoding processes described below, and thus detailed description thereof is omitted here.

In some embodiments, when the digital part of the first encoded data is generated according to the high-information portion of the first image frame as shown in FIG. 10, generating the reconstructed frame of the digital part of the first encoded data can include applying the inverse quantization, inverse transform, and inter-prediction on the quantized transform coefficients corresponding to the digital part of the first encoded data to generate a digitally reconstructed portion of the reconstructed frame, and forming the reconstructed frame by substituting pixel values of the reconstructed portion corresponding to the analog part of the first encoded data by a constant value, such as zero.

Referring again to FIG. 8, at 806, a third image frame is inter-encoded with reference to the second image frame to generate third encoded data. In some embodiments, the reference frame for inter-encoding the third image frame can be a reconstructed frame reconstructed from the second image frame. The third image frame can be a P-frame.

The processes of inter-encoding the third image frame with reference to the second image frame to generate the third encoded data are similar to the processes of inter-encoding the second image frame with reference to the reconstructed frame of the digital part of the first image frame at 804. The detailed description thereof is omitted here.

In some embodiments, any image frame after the second image frame and between the first I-frame (i.e., the first image frame) and a second I-frame, i.e., an I-frame following the first I-frame without another I-frame therebetween, can be inter-encoded with reference to a past image frame (a neighboring frame that was obtained before the image frame).

Exemplary image decoding methods consistent with the disclosure will be described in more detail below. An image decoding method consistent with the disclosure can be implemented in a receiving terminal consistent with the disclosure, such as the receiving terminal 150 of the image transmission system 100 described above.

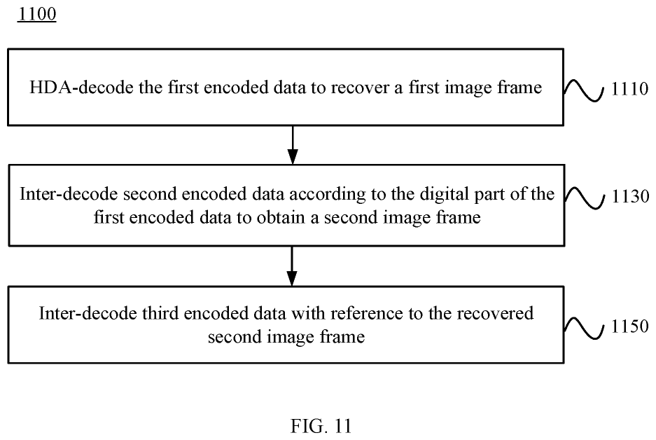

FIG. 11 is a flow chart showing an exemplary image decoding method 1100 consistent with the disclosure. According to the image decoding method 1100, a decoder of the receiving terminal, such as the decoder 153 of the receiving terminal 150 described above, can decode the I-frames according to the HDA coding technique and decode the P-frames according to the digital coding technique. That is, both analog decoding operation and digital decoding operation are performed on the I-frames and only digital decoding operation is performed on the P-frames. Since the HDA coding technique integrates the advantages of digital coding (e.g., high-coding efficiency) and analog coding (e.g., graceful degradation with channels), the problem that the I-frames are difficult to compress and difficult to match with the channel capacity can be solved. Furthermore, because only the digital coding is performed on the P-frames, the problems of insufficient bandwidth and limited transmission quality in the conventional HDA transmission systems which apply the HDA coding on all of the frames can be solved.

As shown in FIG. 11, at 1110, the first encoded data is HDA decoded to recover a first image frame. The first encoded data includes a digital part and an analog part. Any suitable HDA coding standard can be adopted here. In some embodiments, the HDA coding standard used in encoding the first image frame at 802 can be used here.

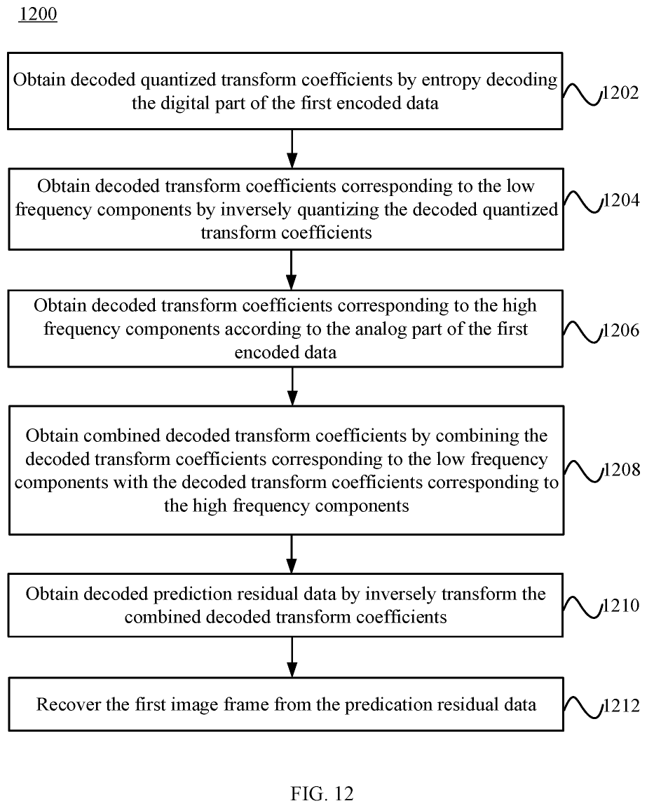

FIG. 12 is a flow chart showing an exemplary HDA decoding method 1200 consistent with the disclosure. According to the HDA decoding method 1200, the low frequency components of the first image frame can be recovered from the digital part of the first encoded data and the high frequency components of the first image frame can be recovered from the analog part of the first encoded data. As such, the advantage of digital transmission can be utilized to ensure the low frequency components of the first image frame can be correctly recovered in the decoder of the receiving terminal, such as the decoder 153 of the receiving terminal 150 described above. The high frequency components of the first image frame can be gracefully degraded with the transmission channel. The problem that the I-frames are difficult to compress and difficult to match with the channel capacity can be solved.

Here, a whole frame or a block of the frame, such as a macroblock (MB), a sub-block, or the like can be decoded, corresponding to the encoding process. For example, if a whole frame is encoded all together at once, the whole frame can be decoded all together. On the other hand, if a frame is encoded block by block, the frame can be decoded block by block.

As shown in FIG. 12, at 1202, decoded quantized transform coefficients are obtained by entropy decoding the digital part of the first encoded data.

The entropy decoding process can convert the digital part of the first encoded data into the decoded quantized transform coefficients. An entropy decoding technique corresponds to the entropy encoding technique used for generating the digital part of the first image frame can be used. For example, when Huffman coding is employed in the entropy encoding process, Huffman decoding can be used in the entropy decoding process. As another example, when Arithmetic coding is employed in the entropy encoding process, Arithmetic decoding can be used in the entropy decoding process.

At 1204, decoded transform coefficients corresponding to the low frequency components are obtained by inversely quantizing the decoded quantized transform coefficients. The decoded quantized transform coefficients can be multiplied by the the quantization step size Qₛₜₑₚ to generate the decoded transform coefficients corresponding to the low frequency components.

At 1206, decoded transform coefficients corresponding to the high frequency components are obtained according to the analog part of the first encoded data.

In some embodiments, the decoded transform coefficients corresponding to the high frequency components are directly included in the analog part of the first encoded data.

In some embodiments, the coefficients of the frequency components that were discarded at 905 can be substituted by zero.

At 1208, combined decoded transform coefficients are obtained by combining the decoded transform coefficients corresponding to the low frequency components with the decoded transform coefficients corresponding to the high frequency components. For example, the decoded transform coefficients corresponding to the low frequency components can be added to the decoded transform coefficients corresponding to the high frequency components to form the combined decoded transform coefficients.

At 1210, the decoded prediction residual data are obtained by inversely transform the combined decoded transform coefficients. An inverse transform algorithm corresponds to the transform algorithm employed for encoding the first image frame can be used here. For example, in H.264, if the 4×4 or 8×8 integer transform derived from the DCT is employed in the transform process, the 4×4 or 8×8 inverse integer transform can be used in the inverse transform process.

At 1212, the first image frame is recovered from the prediction residual data.

In some embodiments, recovering the first image frame can include obtaining recovered predicted data according to a prediction mode. A prediction mode corresponds to the intra-prediction mode that is employed for intra-encoding the first image frame can be used in obtaining the recovered predicted data. The implementation of the prediction process is similar to the implementation of the intra-prediction process described above at 903. The detailed description thereof is omitted here.

The decoded prediction residual frame can be added to the recovered predicted data to generate the recovered first image frame.

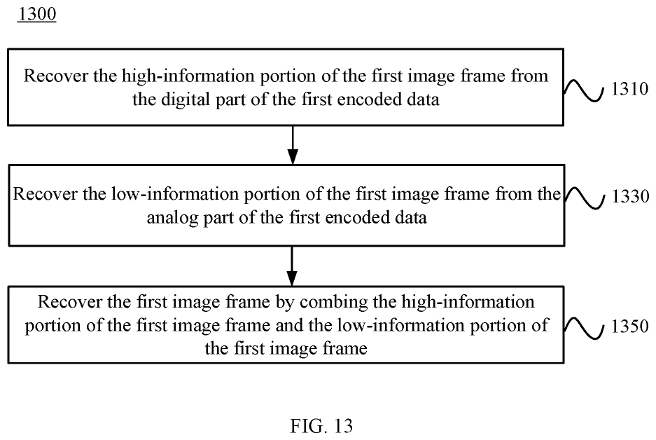

FIG. 13 is a flow chart showing another exemplary HDA decoding method 1300 consistent with the disclosure. According to the HDA decoding method 1300, the blocks of the first image frame containing large amounts of information can be recovered from the digital part of the first encoded data and the blocks of the first image frame containing small amounts of information can be recovered from the analog part of the first encoded data. As such, the advantage of digital transmission can be utilized to ensure the important image data can be correctly recovered in the decoder of the receiving terminal, such as the decoder 153 of the receiving terminal 150 described above. The less important image data can be gracefully degraded with the transmission channel. The problem that the I-frames are difficult to compress and difficult to match with the channel capacity can be solved.

As shown in FIG. 13, at 1310, the high-information portion of the first image frame is recovered from the digital part of the first encoded data. That is, the high-information portion of the first image frame is recovered by intra-decoding the digital part of the first encoded data. In some embodiments, the high-information portion of the first image frame can be processed/decoded block by block.

Intra-decoding the digital part of the first encoded data can be accomplished according to any suitable digital coding standard that is employed in intra-encoding the high-information portion of the first image frame at 1040.

Intra-decoding the digital part of the first encoded data can include applying entropy decoding, inverse quantization, inverse transform, and prediction to the digital part of the first encoded data. The implementation of the entropy decoding, inverse quantization, inverse transform, and prediction processes are similar to those shown in FIG. 12, and thus detailed description thereof is omitted here.

At 1330, the low-information portion of the first image frame is recovered from the analog part of the first encoded data. In some embodiments, the low-information portion of the first image frame can be recovered by analog-decoding the analog part of the first encoded data.

Analog-decoding the analog part of the first encoded data can include the inverse transform process. The inverse transform process can transform the frequency components back to pixel values of the low-information portion of the first image frame. An inverse transform algorithm corresponding to the transform algorithm employed for analog-encoding the low-information portion of the first image frame can be used here. For example, if the DCT is used in analog-encoding the low-information portion of the first image frame, the inverse DCT can be used to obtain pixel values of the low-information portion of the first image frame.

In some embodiments, a substitution process can be performed before inverse transform. For example, when the DCT components that do not contribute to the information in the low-information portion of the first image frame were discarded at 1060, the coefficients of the discarded DCT components can be substituted by zero.

At 1350, the first image frame is recovered by combing the high-information portion of the first image frame and the low-information portion of the first image frame.

Referring again to FIG. 11, at 1130, second encoded data is inter-decoded according to the digital part of the first encoded data to obtain a second image frame. In some embodiments, the second encoded data is inter-decoded with reference to a recovered frame that is recovered from the digital part of the first encoded data.

The inter-decoding process includes applying entropy decoding, inverse quantization and inverse transform, and prediction to the second encoded data.

In the entropy decoding process, the second encoded data is converted into decoded quantized transform coefficients. An entropy decoding technique corresponding to the entropy encoding technique employed for inter-encoding the second image frame can be used here.

In the inverse quantization process, the decoded quantized transform coefficients are multiplied by the quantization step size (Qₛₜₑₚ) to obtain decoded transform coefficients.

In the inverse transform process, the decoded transform coefficients are inversely transformed to generate decoded prediction residual data. An inverse transform algorithm corresponding to the transform algorithm employed for inter-encoding the second image frame can be used here.

In the prediction process, predicted data can be generated with reference to the recovered frame of the digital part of the first encoded data according to a prediction mode. A prediction mode corresponding to the inter-prediction mode employed for inter-encoding the second image frame may be used. The implementation of the prediction process is similar to the implementation of the inter-prediction process 804 described above. The detailed description thereof is omitted here.

In some embodiments, generating the recovered frame of the digital part of the first encoded data including applying entropy decoding, inverse quantization and inverse transform, and prediction to the digital part of the first encoded data.

In some embodiments, when the digital part of the first encoded data is generated according to the high-information portion of the first image frame as shown in FIG. 10, generating the recovered frame of the digital part of the first encoded data can include applying entropy-decoding, inverse quantization, inverse transform, and inter-prediction on the quantized transform coefficients corresponding to the digital part of the first encoded data to generate a digitally recovered portion of the recovered frame, and forming the recovered frame by substituting pixel values of the recovered portion corresponding to the analog part of the first encoded data by a constant value, such as zero.

The decoded prediction residual data can be added to the predicted data to recover the second image frame.

At 1150, third encoded data is inter-decoded with reference to the recovered second image frame.

The processes of inter-decoding the third encoded data with reference to the recovered second image frame to generate the third image frame are similar to the processes of inter-decoding the second encoded data with reference to the recovered frame of the digital part of the first image frame at 1240. The detailed description thereof is omitted here.

In some embodiments, any encoded data after the second encoded data and between the first encoded data and encoded data of a second I-frame, i.e., an I-frame following the first I-frame without another I-frame therebetween, can be inter-decoded with reference to a previously decoded image frame.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. An image encoding method, comprising:
hybrid digital-analog (HDA) encoding a first image frame to generate first encoded data including a digital part and an analog part; and
inter-encoding a second image frame using a reference frame reconstructed from the digital part of the first encoded data to generate second encoded data.

2. The image encoding method according to claim 1, wherein HDA-encoding the first image frame to generate the first encoded data includes:
generating the digital part of the first encoded data from low frequency components of the first image frame; and
generating the analog part of the first encoded data from high frequency components of the first image frame.

3. The image encoding method according to claim 2, wherein HDA-encoding the first image to generate the first encoded data includes:
employing an intra-prediction on the first image frame to obtain prediction residual data;
transforming the prediction residual data into transform coefficients;
generating the analog part of the first encoded data according to the transform coefficients corresponding to the high frequency components;
quantizing the transform coefficients corresponding to the low frequency components to generate quantized transform coefficients; and
entropy encoding the quantized transform coefficients to generate the digital part of the first encoded data.

4. The image encoding method according to claim 2, further including:
determining a threshold to divide the first image frame into the low frequency components and the high frequency components according to at least one of a channel bandwidth, a bit rate, or a resolution of the first image frame.

5. The image encoding method according to claim 1, wherein HDA-encoding the first image frame to generate the first encoded data includes:
generating the digital part of the first encoded data from a high-information portion of the first image frame; and
generating the analog part of the first encoded data from a low-information portion of the first image frame.

6. The image encoding method according to claim 5, wherein generating the digital part of the first encoded data includes:
generating the digital part of the first encoded data by intra-encoding the high-information portion of the first image frame.

7. The image encoding method according to claim 5, wherein generating the analog part of the first encoded data includes:
generating the analog part of the first encoded data by analog-encoding the low-information portion of the first image frame.

8. The image encoding method according to claim 5, wherein HDA-encoding the first image to generate the first encoded data further includes:
dividing the first image frame into the high-information portion and the low-information portion.

9. The image encoding method according to claim 8, wherein dividing the first image frame includes:
dividing the first image frame into a plurality of blocks;
calculating amounts of information in the plurality of blocks; and
assigning the plurality of blocks to the high-information portion of the first image frame or the low-information portion of the first image frame according to the amounts of information of the plurality of blocks.

10. The image encoding method according to claim 1, further including:
inter-encoding a third image frame according to the second encoded data to generate third encoded data.

11. The image encoding method according to claim 10, wherein inter-encoding the third image frame according to the second encoded data includes:
reconstructing the second encoded data to obtain a reference frame, and
inter-encoding the third image frame according to the reference frame to generate the third encoded data.

12. An encoder, comprising:
a processor; and
a memory coupled to the processor and storing instructions that, when executed by the processor, cause the processor to:
hybrid digital-analog (HDA) encode a first image frame to generate first encoded data including a digital part and an analog part; and
inter-encode a second image frame using a reference frame reconstructed from the digital part of the first encoded data to generate second encoded data.

13. The encoder according to claim 12, wherein the instructions further cause the processor to:
generate the digital part of the first encoded data from low frequency components of the first image frame; and
generate the analog part of the first encoded data from high frequency components of the first image frame.

14. The encoder according to claim 13, wherein the instructions further cause the processor to:
employ an intra-prediction on the first image frame to obtain prediction residual data;
transform the prediction residual data into transform coefficients;
generate the analog part of the first encoded data according to the transform coefficients corresponding to the high frequency components;
quantize the transform coefficients corresponding to the low frequency components to generate quantized transform coefficients; and
entropy encode the quantized transform coefficients to generate the digital part of the first encoded data.

15. The encoder according to claim 13, wherein the instructions further cause the processor to:
determine a threshold to divide the first image frame into the low frequency components and the high frequency components according to at least one of a channel bandwidth, a bit rate, or a resolution of the first image frame.

16. The encoder according to claim 12, wherein the instructions further cause the processor to:
generate the digital part of the first encoded data from a high-information portion of the first image frame; and
generate the analog part of the first encoded data from a low-information portion of the first image frame.

17. The encoder according to claim 16, wherein the instructions further cause the processor to:
generate the digital part of the first encoded data by intra-encoding the high-information portion of the first image frame.

18. The encoder according to claim 16, wherein the instructions further cause the processor to:
generate the analog part of the first encoded data by analog-encoding the low-information portion of the first image frame.

19. The encoder according to claim 16, wherein the instructions further cause the processor to:
divide the first image frame into the high-information portion and the low-information portion.

20. An unmanned aerial vehicle (UAV) comprising:
a fuselage;
a propulsion system coupled to the fuselage and including one or more propellers, one or more motors, and an electronic governor;
an image acquiring device coupled to the fuselage and configured to acquire a first image frame and a second image frame; and
a processor configured to encode the image by:
hybrid digital-analog (HDA) encoding the first image frame to generate first encoded data including a digital part and an analog part; and
inter-encoding the second image frame using a reference frame reconstructed from the digital part of the first encoded data to generate second encoded data.
